(19) United States
(12) Patent Application Publication
(10) Pub. No.: US 2009/0003906 A1
(43) Pub. Date: Jan. 1, 2009

(54) IMAGE FORMING APPARATUS

(75) Inventors: Masaru Takeuchi, Handa-shi (JP); Tetsuo Asada, Kuwana-shi (JP); Yukio Shiohara, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/165,434

(22) Filed: Jun. 30, 2008

(30) Foreign Application Priority Data
Jun. 29, 2007 (JP) 2007-171564

(51) Int. Cl. G03G 21/00

(52) U.S. Cl. 399/357

(57) ABSTRACT

An image forming apparatus and a sheet cassette are provided. The image forming apparatus includes a first tray that accommodates sheets; a first transfer path; a forming unit; an arm that can be pivoted; a roller that is rotatably provided at a leading end of the arm and feeds the sheets; a second tray that is provided on the first tray to form a two-stage structure, and can slide in a direction in which the second tray comes into contact with or is separated from the arm; and a cleaning member that is provided on the second tray and cleans the roller. The arm changes posture between a first posture in which the roller is supported upward by the first tray and a second posture in which the roller comes into pressure contact with the cleaning member.

### CROSS REFERENCE TO RELATED APPLICATION

The present application claims priority from Japanese Patent Application No. 2007-171564, which was filed on Jun. 29, 2007, the disclosure of which is herein incorporated by reference in its entirety.

### TECHNICAL FIELD

Apparatuses and devices consistent with the present invention relate to image forming apparatuses, and more particularly, to image forming apparatuses which convey a sheet accommodated in a tray and forms images on the sheet while the sheet is conveyed.

### BACKGROUND

Japanese unexamined patent application publication No. JP-A-5-92641 describes a related art image forming apparatus. In the related art image forming apparatus, a roller comes into pressure contact with recording sheets accommodated in a tray, and in this state, the roller is rotated. Then, the recording sheet is fed from the tray to a transfer path. While the recording sheet is conveyed along the transfer path, ink or toner is adhered to the recording sheet. In this way, a desired image is recorded on the recording sheet. As described above, since the roller is rotated while coming into pressure contact with the recording sheet, for example, paper powder or dust on the recording sheet is adhered to the roller. As the amount of paper powder or dust that adheres to the roller increases, the ability of the roller to pickup a sheet decreases, and a paper jam or a sheet feed error may occur. In order to address this problem, the related art image forming apparatus is provided with a unit that cleans the roller.

In the related image forming apparatus, a cleaning unit is provided that includes a cleaning sheet detachably provided in the tray. The cleaning sheet is formed by providing a hook and a sponge-shaped cleaning fabric on a board. The cleaning sheet is fixed to the tray by the hook. The tray that has the cleaning sheet fixed thereto, but no recording sheet loaded thereon is mounted to a printer body. Then, the roller comes into contact with the cleaning fabric. In this state, when a sheet feed button is pushed, the roller is rotated and cleaned by the cleaning fabric.

However, the related art image forming apparatus has a number of disadvantages. For example, in the related art image forming apparatus, before cleaning the roller, it is necessary to take out the recording sheets from the tray, fix the cleaning sheet to the tray, and mount the tray to the printer. After cleaning the roller, it is necessary to detach the cleaning sheet from the tray, load the recording sheets to the tray, and mount the tray to the printer. Accordingly, this process is cumbersome and difficult to perform.

Further, in the related art image forming apparatus, it is necessary to form the cleaning sheet according to the shape of the tray and the arrangement of the roller. Therefore, the overall structure of the image forming apparatus becomes complicated, which results in an increase in the manufacturing costs of the image forming apparatus.

### SUMMARY

Accordingly, it is an aspect of the present invention to provide an image forming apparatus capable of cleaning a roller with a simple structure, without taking out sheets from a tray, providing a cleaning member, or removing the cleaning member.

Exemplary embodiments of the present invention address the above disadvantages and other disadvantages not described above. However, the present invention is not required to overcome the disadvantages described above, and thus, an exemplary embodiment of the present invention may not overcome any of the problems described above.

According to an aspect of the invention, an image forming apparatus includes a first tray that accommodates sheets; a first transfer path along which the sheet fed from the first tray is conveyed; a forming unit that forms images on the sheet while the sheet is conveyed; an arm that can be pivoted about a fulcrum in a direction in which the arm comes into contact or is separated from the first tray; a roller that is rotatably provided at a leading end of the arm and feeds the sheets on the first tray to the first transfer path; a second tray that is provided on the first tray to form a two-stage structure, and can slide in a direction in which the second tray comes into contact with or is separated from the arm; and a cleaning member that is provided on the second tray and cleans the roller. The arm changes posture between a first posture in which the roller is supported upward by the first tray and a second posture in which the roller comes into pressure contact with the cleaning member, in operative association with the sliding of the second tray.

According to another exemplary embodiment of the present invention, there is provided a sheet cassette comprising a first tray that accommodates sheets; a second tray that is disposed on the first tray, wherein a length of the second tray is less than a length of the first tray such that the second tray is slidable along the first tray in a direction of insertion of the sheet cassette into an image forming apparatus; and a cleaning member that is provided on the second tray, wherein the second tray is slidable along the first tray between a first position in which a roller of the image forming apparatus contacts the sheets in the first tray, and a second position in which the roller contacts the cleaning member on the second tray.

### BRIEF DESCRIPTION OF THE DRAWINGS

Illustrative aspects of the invention will be described in detail with reference to the following figures wherein:

FIG. 1 is a perspective view illustrating a multifunction device according to an exemplary embodiment of the present invention;

FIG. 2 is a longitudinal cross-sectional view illustrating an internal structure of the multifunction device of FIG. 1;

FIG. 3 is an enlarged cross-sectional view illustrating a path switching unit of the multifunction device of FIG. 1, and showing a frame maintained in a horizontal posture;

FIG. 4 is a perspective view illustrating a sheet cassette of the multifunction device of FIG. 1, and showing a second tray separated from a separating plate;

FIG. 5 is a perspective view illustrating the sheet cassette of FIG. 4, and showing the second tray rotated upward relative to a main tray;

FIG. 6 is a perspective view illustrating the sheet cassette of FIG. 4, and showing a leading end of the second tray coming into contact with the separating plate;

FIGS. 7A to 7C are diagrams schematically illustrating the sheet cassette of FIG. 4, specifically, FIG. 7A shows the second tray disposed at a first position, FIG. 7B shows the second tray disposed at a second position, and FIG. 7C shows the second tray disposed at a third position;

FIGS. 8A to 8C are diagrams illustrating the sheet cassette of FIG. 4, showing feed rollers coming into pressure contact with a cleaning member; and

FIGS. 9A to 9C are diagrams illustrating the sheet cassette of FIG. 4, showing a sliding of a sheet discharging tray relative to the main tray.

### DETAILED DESCRIPTION OF EXEMPLARY EMBODIMENTS OF THE PRESENT INVENTION

Hereinafter, exemplary embodiments of the invention will be described with reference to the accompanying drawings. The exemplary embodiments of the invention are illustrative, and various modifications and changes to the invention can be made without departing from the scope and spirit of the invention.

### First Exemplary Embodiment

First, the structure and operation of a multifunction device 10, which is an example of an image forming apparatus according to a first exemplary embodiment of the present invention, will be described.

### <Multifunction Device>

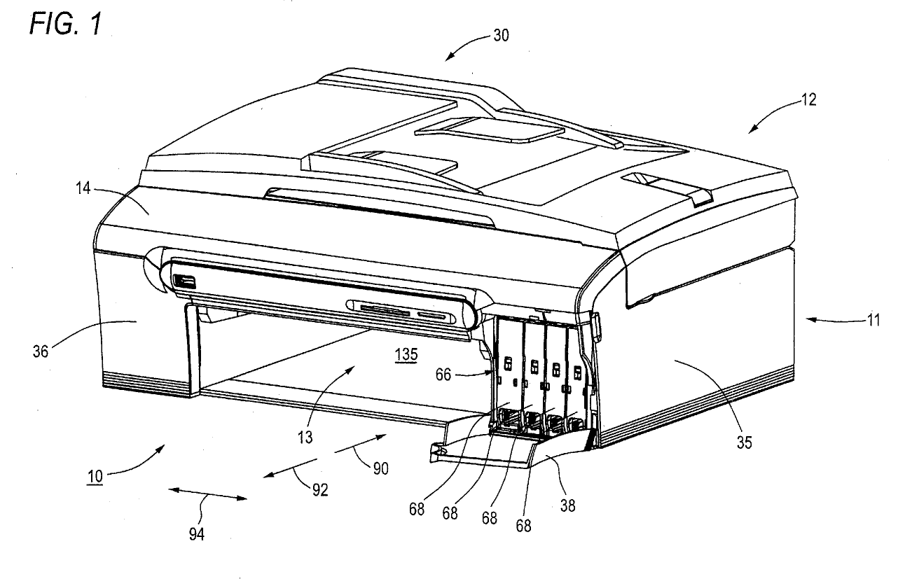

FIG. 1 is a perspective view illustrating the multifunction device 10 according to the first exemplary embodiment of the present invention.

As shown in FIG. 1, the multifunction device (MDF) 10 includes a printer 11 and a scanner 12, and has a print function, a scan function, a copy function, and a facsimile function. An image forming apparatus according to the exemplary embodiments serves as the printer 11 of the multifunction device 10. In the exemplary embodiments, the printer 11 is an ink jet printer that uses ink to form images. However, the printer 11 may be a laser printer that uses toner to form images.

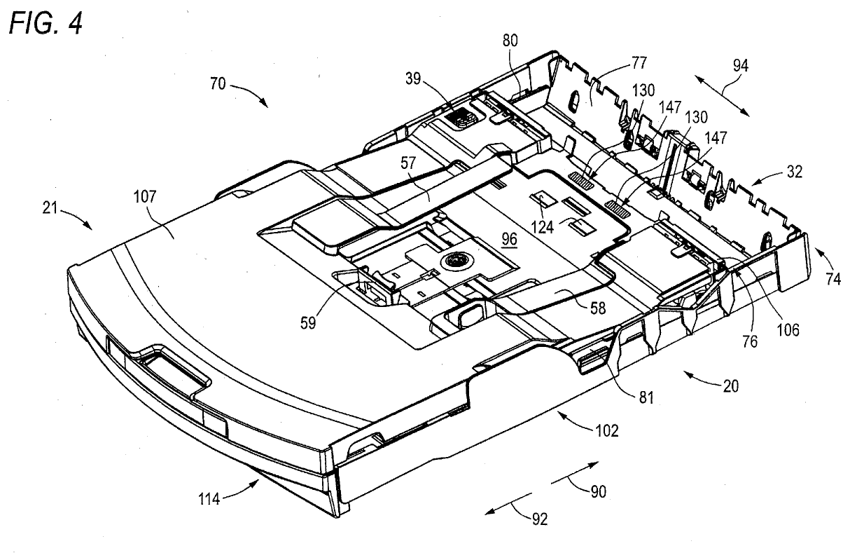

As shown in FIG. 1, the multifunction device 10 is formed in a substantially rectangular parallelepiped shape in which the height is smaller than the width and the length. The printer 11 is provided at a lower part of the multifunction device 10. The printer 11 has an opening 13 formed in a front surface 36 of a device body 35. A sheet cassette 70 (for example, see FIG. 4), which will be described below, is inserted into the device body 35 through the opening 13. The sheet cassette 70 accommodates recording sheets, and includes a main tray 20 and a second tray 21 (see FIGS. 4 to 6). The sheet cassette 70 is inserted into the device body 35 through the opening 13 and disposed in a space 135.

Image data of a document scanned by the scanner 12 or print data transmitted from an external apparatus is input to the printer 11. The printer 11 forms images on the recording sheet fed from the sheet cassette 70 on the basis of the data.

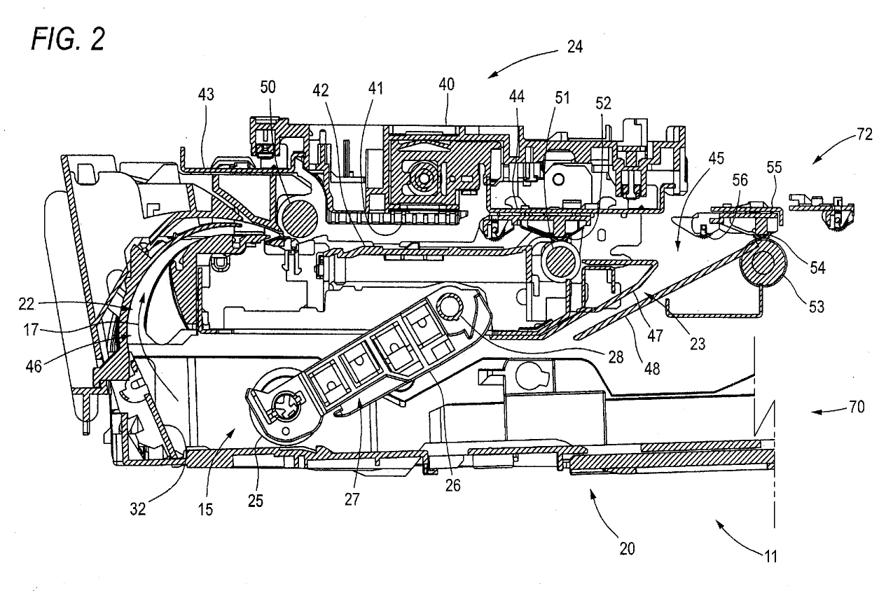

A door 38 (see FIG. 1) is openably provided at the lower right side of the front surface 36 of the device body 35. A cartridge mounting unit 66 to which an ink cartridge 68 is mounted is provided inside the door 38. The ink cartridge 68 is mounted to the cartridge mounting unit 66 and connected to an ink jet recording head 41 (see FIG. 2) through an ink tube.

The scanner 12 is provided at an upper part of the multifunction device 10. The scanner 12 includes a flat bed scanner (FBS) and an automatic document feeder (ADF). As shown in FIG. 1, a document cover 30, serving as a top board of the multifunction device 10, is openably provided. The ADF is provided in the document cover 30. Although not shown in FIG. 1, a platen glass and an image sensor are provided below the document cover 30. In the scanner 12, the image sensor scans the image of the document loaded on the platen glass, or the image of the document conveyed by the ADF.

A control panel 14 is provided at an upper front side of the multifunction device 10 (see FIG. 1). The control panel 14 includes a liquid crystal display for displaying various information items and input keys inputting information. In FIG. 1, the liquid crystal display and the input keys are not shown. The multifunction device 10 operates on the basis of information input from the control panel 14, or information transmitted from an external apparatus (for example, a PC).

### <Printer>

Next, the structure of the printer 11 will be described in detail.

FIG. 2 is a longitudinal cross-sectional view illustrating the internal structure of the printer 11. In FIG. 2, a portion of the main tray 20 (see FIG. 4) and the second tray 21 (see FIG. 4) are not shown.

As shown in FIG. 2, the printer 11 includes a sheet cassette 70, feed rollers 25, an arm 26, and a power transmission mechanism 27.

A shaft 28 is provided above the main tray 20 in the width direction of the device body 35 (direction vertical to the plane of FIG. 2). The shaft 28 is rotatably supported by the device body 35. A motor (not shown) is connected to one end of the shaft 28. When the motor is driven, a rotating force (torque) in a predetermined direction is transmitted to the shaft 28.

The base of the arm 26 is connected to the shaft 28. Therefore, the arm 26 is supported by the shaft 28 so as to be pivotable about the shaft in the direction that it comes into contact with or is separated from the main tray 20. The arm 26 extends from the shaft 28 to the rear side of the device (the left side of FIG. 2) in the vicinity of the center of the device body 35 in the width direction. Two feed rollers 25 are rotatably provided at the leading end of the arm 26. Although not shown in the drawings, the feed rollers 25 are provided at both sides of the arm 26 in a first direction 94 (direction vertical to the plane of FIG. 2). The feed rollers 25 are supported by the arm such that they can come into contact with or be separated from the recording sheets loaded on the sheet cassette 70. The arm 26 is pivoted and urged downward to the sheet cassette 70 by the weight of the arm 26 or the feed rollers 25 or a spring.

The power transmission mechanism 27 is provided in the arm 26. The power transmission mechanism 27 includes a plurality of gears that are engaged in series with each other. A rotating force transmitted to the shaft 28 is transmitted to the feed rollers 25 through the power transmission mechanism 27, such that the feed rollers 25 are rotated. When the feed rollers 25 are rotated while coming into pressure contact with the recording sheets on the sheet cassette 70, the uppermost recording sheet is conveyed to an inclined plate 32 by a frictional force between the roller surfaces of the feed rollers 25 and the recording sheet. When the leading end of the recording sheet comes into contact with the inclined plate 32, the uppermost one of a stack of recording sheets is guided upward. In this way, the recording sheets are fed one by one from the sheet cassette 70 to the first transfer path 22.

The first transfer path 22 is provided above the inclined plate 32. The first transfer path 22 is curved in a U shape that extends upward from the inclined plate 32 and then bent to the front surface 36 (the right side of FIG. 2) in a side view. (see FIG. 1) The first transfer path 22 extends from the rear side (the left side of FIG. 2) to the front surface 36 of the multifunction device 10, and communicates with the opening 13 (see FIG. 1) formed in the front surface 36 of the device body 35 through the forming unit 24. Therefore, the recording sheet that is fed from the sheet cassette 70 to the first transfer path 22 by the feed rollers 25 is guided so as to U-turn from a lower side to an upper side along the first transfer path 22, and reaches the forming unit 24. Then, the forming unit 24 forms images on the recording sheet, and discharges the recording sheet to the opening 13.

As shown in FIG. 2, the forming unit 24 includes a carriage 40, an ink jet recording head 41, and a platen 42. The ink jet recording head 41 is mounted to the carriage 40. The carriage 40 reciprocates along guide rails 43 and 44 in the width direction of the recording sheet (a direction vertical to the plane of FIG. 2). Although not shown in FIG. 2, a known belt driving mechanism that is driven by a motor is provided in the guide rail 44. The carriage 40 is connected to a driving belt of the belt driving mechanism. When the motor is driven, a driving force thereof is transmitted to the carriage 40 through the belt driving mechanism, and the carriage 40 reciprocates.

As shown in FIG. 2, the platen 42 is opposite to the ink jet recording head 41 with the first transfer path 22 interposed therebetween. The platen 42 supports upward the recording sheet conveyed along the first transfer path 22. The platen 42 causes the recording sheet to be conveyed below the ink jet recording head 41 with a head gap between the recording sheet and the ink jet recording head 41. Various color inks contained in the ink cartridge 68 (see FIG. 1) are supplied to the ink jet recording head 41 through ink tubes. While the carriage 40 reciprocates, various color inks are selectively discharged as minute ink droplets from the ink jet recording head 41 to the platen 42. In this way, the ink jet recording head 41 forms images on the recording sheet that is conveyed on the platen 42 during the conveying operation.

As shown in FIG. 2, a second transfer path 23 connects the first transfer path 22 and the main tray 20. Specifically, one end of the second transfer path 23 is connected to the downstream side (a downstream-side portion 45) of the forming unit 24 in the first transfer path 22. The other end of the second transfer path 23 is connected to a portion of the main tray 20 that is arranged on the upstream side (the right side of FIG. 2) of the feed rollers 25. The downstream side (the left side of FIG. 2) of the feed rollers 25 in the main tray 20 is connected to the first transfer path 22 through the inclined plate 32. Therefore, the second transfer path 23 is connected to the upstream side (an upstream-side portion 46) of the forming unit 24 in the first transfer path 22 through the main tray 20.

The second transfer path 23 is defined by a pair of an upper guide member 47 and a lower guide member 48 that are opposite to each other with a predetermined gap therebetween. The upper guide member 47 and the lower guide member 48 extend in an oblique direction from the downstream-side portion 45 of the first transfer path 22 to the upstream side of the feed rollers 25.

A transfer unit 15 conveys the recording sheets along the first transfer path 22 and the second transfer path 23. The transfer unit 15 includes the feed rollers 25, a transfer roller 50, a discharge roller 51, and a path switching unit 72.

As shown in FIG. 2, the transfer roller 50 is provided on the upstream side (the left side of FIG. 2) of the forming unit 24 in the first transfer path 22 in the direction in which the recording sheet is conveyed. Although not shown in the drawings, a plurality of pinch rollers are provided below the transfer roller 50 so as to come into pressure contact with the transfer roller 50. The transfer roller 50 is provided in the width direction (in a direction vertical to the plane of FIG. 2) of the first transfer path 22. The plurality of pinch rollers are arranged at intervals in the width direction of the first transfer path 22. The recording sheet that is conveyed along the first transfer path 22 is pinched between the transfer roller 50 and the pinch rollers, and then conveyed onto the platen 42.

As shown in FIG. 2, the discharge roller 51 and a plurality of spurs 52 are provided on the downstream side (the right side of FIG. 2) of the forming unit 24 in the first transfer path 22 in the direction in which the recording sheet is conveyed. The spurs 52 are provided above the discharge roller 51 and come into pressure contact with the discharge roller 51. The discharge roller 51 is provided in the width direction of the first transfer path 22. The plurality of spurs 52 are arranged at intervals in the width direction of the first transfer path 22. The recording sheet having an image formed thereon is pinched between the discharge roller 51 and the spurs 52, and then conveyed to the downstream-side portion 45 of the first transfer path. The transfer roller 50 and the discharge roller 51 are driven by a motor (not shown), which is a driving source.

As shown in FIG. 2, the path switching unit 72 is provided in the downstream-side portion 45 of the first transfer path 22. The path switching unit 72 includes a switch back roller 53, spurs 54, a frame 55, and spurs 56.

As shown in FIG. 2, the switch back roller 53 and a plurality of spurs 54 are provided immediately below the downstream-side portion 45 of the first transfer path 22. The switch back roller 53 is provided in the width direction of the first transfer path 22. The plurality of spurs 54 are arranged at intervals in the width direction of the first transfer path 22. The spurs 54 are supported by the frame 55 that is provided above the switch back roller 53. The rotating shaft of the spurs 54 is elastically urged by a coil spring to come into pressure contact with the switch back roller 53. Therefore, when the switch back roller 53 is rotated, the spurs 54 are also rotated with the rotation of the switch back roller 53.

The switch back roller 53 is driven by a motor (not shown), which is a driving source. The switch back roller 53 can be rotated forward and backward. The forward or backward rotation direction of the switch back roller 53 is controlled by the driving of the motor. When the switch back roller 53 is rotated forward, the recording sheet conveyed along the first transfer path 22 is discharged to the space 135 (see FIG. 1) and then ejected from the opening 13. In addition, when the switch back roller 53 is rotated backward, the recording sheet conveyed along the first transfer path 22 is switched back and conveyed to the second transfer path 23.

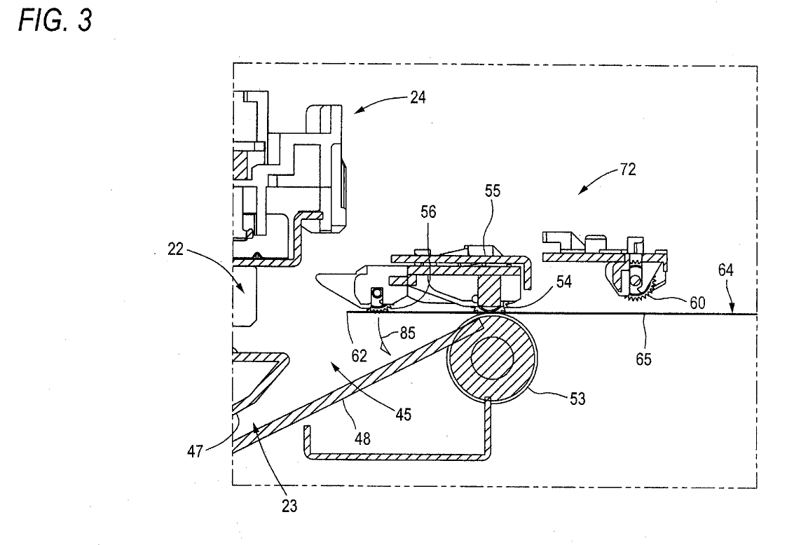

FIG. 3 is an enlarged cross-sectional view illustrating the path switching unit 72, and shows the frame 55 maintained in a horizontal posture.

The path switching unit 72 includes the frame 55 and a plurality of spurs 56. The switch back roller 53 is rotatably supported by the frame 55. The frame 55 extends from the switch back roller 53 to the upstream side of the conveyance direction (to the left side of FIG. 3), and reaches the downstream-side portion 45. The spurs 56 are rotatably supported by the end of the extending portion of the frame 55, and the spurs 56 are arranged in the downstream-side portion 45. The frame 55 extends in the width direction (direction vertical to the plane of FIG. 3) of the first transfer path 22. The plurality of spurs 56 are arranged at intervals in the width direction of the first transfer path 22.

The frame 55 is configured such that the end of the extending portion thereof can rotate on the rotating shaft of the switch back roller 53. A driving force of a motor (not shown) is transmitted to the frame 55. Then, the frame 55 is rotated in the direction of an arrow 85 from the state shown in FIG. 3 to a rotation posture. The spurs 54 and the spurs 56 rotate on the rotating shaft of the switch back roller 53 together with the frame 55. When the frame 55 is maintained in the horizontal posture, the recording sheet 65 is guided in the direction in which the recording sheet is discharged to the space 135 toward the opening 13. When the frame 55 is maintained in the rotation posture, the recording sheet 65 is guided in the direction in which the recording sheet passes through the second path 23.

### <Sheet Cassette>

Next, the structure of the sheet cassette 70 will be described with reference to FIGS. 4 to 6.

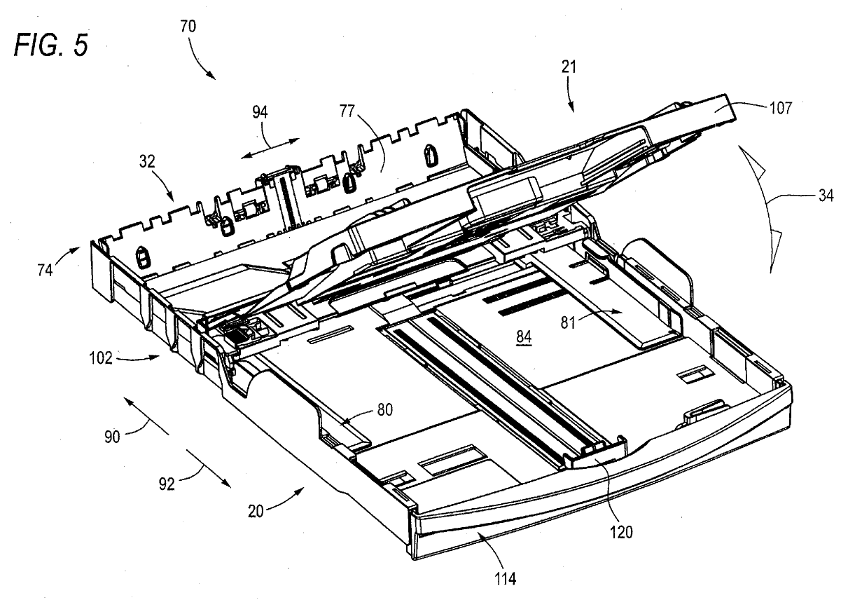

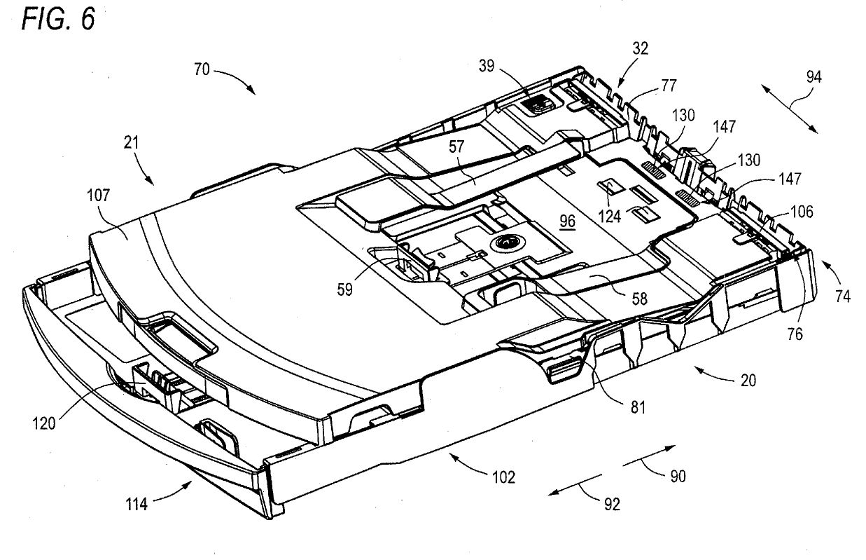

FIG. 4 is a perspective view the appearance of the sheet cassette 70, and shows the second tray 21 separated from the separating plate 32. FIG. 5 is a perspective view illustrating the appearance of the sheet cassette 70, and shows the second tray 21 that is rotated upward from the main tray 20. FIG. 6 is a perspective view illustrating the appearance of the sheet cassette 70, and shows the second tray 21 with the leading end 76 thereof coming into contact with the separating plate 32.

As shown in FIGS. 4 to 6, the sheet cassette 70 includes the main tray 20 and the second tray 21 that are integrally formed with each other. Specifically, the sheet cassette 70 has a two-stage structure of the main tray 20 and the second tray 21 in which the second tray 21 is arranged on the main tray 20. Therefore, when the main tray 20 is inserted into the device body 35, the second tray 21 is also inserted thereinto.

The sheet cassette 70 is configured such that the second tray 21 is pivotable upward with respect to the main tray 20 using a first direction 94 as an axis. The first direction 94 is a horizontal direction that is substantially orthogonal to the slide direction of the second tray 21 (an insertion direction 90 and a drawing direction 92). As shown in FIG. 5, the second tray 21 is raised with respect to the main tray 20. In this way, an upper surface of the main tray 20 is opened, and recording sheets can be loaded to the main tray 20. As shown in FIG. 4, the second tray 21 is closed with respect to the main tray 20. In this way, the upper surface of the main tray 20 is covered with the second tray 21. In this state, the second tray 21 serves as both a storage for recording sheets and a cover for the main tray 20.

### <Main Tray>

As shown in FIG. 5, the main tray 20 is formed in a substantially rectangular dish shape in plan view that is elongated in the insertion direction 90 and the drawing direction 92. The insertion direction 90 denotes a direction in which the sheet cassette 70 is inserted into the device body 35. The drawing direction 92 denotes a direction in which the sheet cassette 70 is drawn from the device body 35. The insertion direction 90 and the drawing direction 92 denote slide directions. The main tray 20 includes a tray body 102 and an extension tray 114. The main tray 20 is configured such that the extension tray 114 can slide relative to the tray body 102 in the insertion direction 90 or the drawing direction 92. The extension tray 114 slides relative to the tray body 102 in the insertion direction 90 or the drawing direction 92, if necessary. In this way, the sheet loading surface of the main tray 20 is extended or contacted, which makes it possible to accommodate recording sheets of various sizes in the main tray 20. For example, letter-size recording sheets and A4 or B5 size recording sheets defined by a JIS standard are accommodated in the main tray 20.

As shown in FIG. 5, the tray body 102 includes a lower plate 84. The recording sheets are loaded on the lower plate 84. The inclined plate 32 is provided at the leading end 74 of the tray body 102. The inclined plate 32 is a plate member that is elongated in the width direction (the first direction 94) of the tray body 102. The inclined plate 32 is inclined toward the rear side of the device (in the insertion direction 90). Therefore, when the leading end of the recording sheet comes into contact with the inclined plate 32, the leading end is guided along an inner surface 77 of the inclined plate 32 in the oblique direction. That is, the inner surface 77 serves as a guide surface that guides the recording sheet to the first transfer path 22 (see FIG. 2).

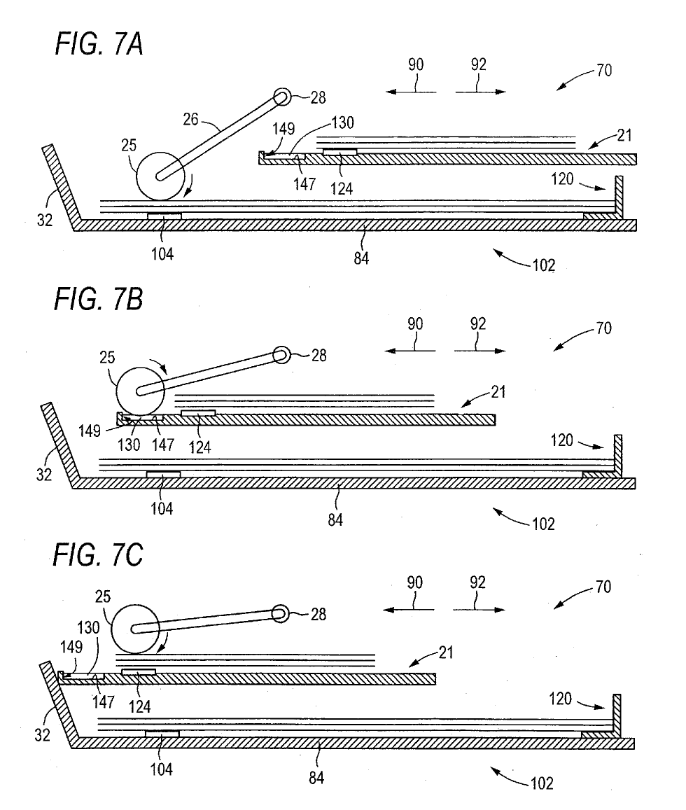

A friction member 104 (see FIG. 7A) is provided at the center of the tray body 102 in the first direction 94 (the direction vertical to the plane of FIG. 7). The friction member 104 is formed of, for example, cork or rubber having a large friction coefficient with respect to the recording sheet. When the arm 26 is rotated downward such that the feed rollers 25 are disposed on the main tray 20, the feed rollers 25 come into pressure contact with the recording sheets on the main tray 20. Then, the recording sheets on the main tray 20 are pinched between the friction member 104 and the feed rollers 25. A frictional force is applied in the insertion direction 90 from the feed rollers 25 to the uppermost one of a plurality of recording sheets pinched between the friction member 104 and the feed rollers 25. In this way, the frictional force is applied from the friction member 104 to the lowermost recording sheet in the drawing direction 92.

As shown in FIG. 5, side guides 80 and 81 are provided on the sides of the lower plate 84 of the tray body 102. The side guides 80 and 81 are configured so as to slide on the lower plate 84 in the first direction 94. One of the side guides 80 and 81 slides in the first direction 94. In operative association with the sliding of the one side guide, the other one of the side guides 80 and 81 slides in the opposite direction. When the side guides 80 and 81 slid in this way, the central position of the recording sheet on the main tray 20 in the width direction is substantially aligned with the center of the main tray 20 in the width direction.

A rear guide 120 is provided at the center of the tray body 102 in the first direction 94. The rear guide 120 slides in the insertion direction 90 with the recording sheets loaded on the main tray 20. In this way, the rear guide 120 comes into contact with the trailing ends of the recording sheets. As a result, the trailing ends of the recording sheets are aligned with each other, and the positions of the trailing ends of the recording sheets are restricted according to the sizes of the recording sheets. The trailing ends of the recording sheets are located at a position in the vicinity of the inclined plate 32 in the main tray 20, regardless of the sizes of the recording sheets.

### <Second Tray>

As shown in FIGS. 4 to 6, the second tray 21 is provided on the main tray 20. The second tray 21 mainly accommodates thick and small recording sheets. For example, the second tray 21 accommodates post cards, envelopes, L-size glossy photographic papers, etc. The second tray 21 is configured so as to slide relative to the main tray 20 in the insertion direction 90 and the drawing direction 92 (see FIGS. 4 and 6).

The width of the second tray 21 is substantially equal to that of the main tray 20, and the length thereof in the insertion direction 90 and the drawing direction 92 is slightly smaller than that of the main tray 20. That is, the second tray is formed in a rectangular shape in plan view. Side guides 57 and 58 are provided in the second tray 21. The recording sheets are accommodated in a region of the second tray 21 surrounded by the side guides 57 and 58. The structure of the side guides 57 and 58 is similar to that of the side guides 80 and 81 of the main tray 20 except for the shapes and slide ranges of the side guides 57 and 58.

As shown in FIGS. 4 to 6, the second tray 21 includes a sliding portion 106 and a rotating portion 107. The sliding portion 106 is a plate member whose width in the first direction 94 is substantially equal to that of the main tray 20. The sliding portion 106 is provided in the main tray 20 so as to slide in the direction (the insertion direction 90 and the drawing direction 92) in which it comes into contact with or is separated from the arm 26.

The rotating portion 107 is a plate member whose width is substantially equal to that of the main tray 20. The rotating portion 107 is configured so as to rotate in the direction of an arrow 34 (see FIG. 5) relative to the sliding portion 106. The side guides 57 and 58 are provided on a lower plate 96 of the rotating portion 107 (see FIGS. 4 and 6).

As shown in FIGS. 4 and 6, two friction members 124 are provided at the center of the lower plate 96 in the first direction 94. The friction members 124 are provided at positions corresponding to the two feed rollers 25 in the first direction 94. Similar to the friction member 104 (see FIG. 7), the friction members 124 are formed of, for example, cork or rubber having a large friction coefficient with respect to the recording sheet. When the arm 26 is rotated such that the feed rollers 25 are disposed on the second tray 21, the feed rollers 25 come into pressure contact with the recording sheets on the second tray 21. Then, the recording sheets on the second tray 21 are pinched between the friction members 124 and the feed rollers 25. A frictional force is applied in the insertion direction 90 from the feed rollers 25 to the uppermost one of the recording sheets pinched between the friction member 124 and the feed rollers 25. In this way, the frictional force is applied from the friction members 124 to the lowermost recording sheet in the drawing direction 92.

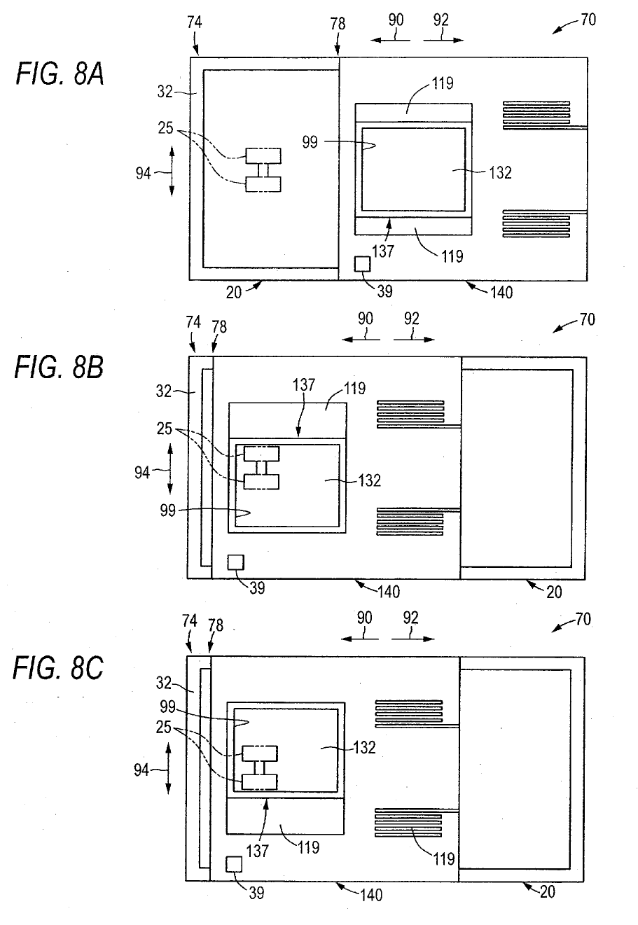

As shown in FIGS. 4 and 6, two concave portions 147 are formed at the center of the lower plate 96 in the first direction 94. The two concave portions 147 are provided at positions respectively corresponding to the two feed rollers 25 in the first direction 94. The concave portions 147 are provided closer to the leading end 76 of the second tray 21 than to the friction members 124. The concave portions 147 are recessed downward from the upper surface of the lower plate 96 (see FIG. 8A). Cleaning members 130 are accommodated in the concave portions 147 (see FIGS. 4, 6, and 8A). A stopper 149 is provided in a portion of each of the concave portions 147 close to the leading end 76 of the second tray 21 (at the left side of FIG. 7A). The stopper 149 restricts the movement of the cleaning member 130 to the first transfer path 22, and forms a portion of the wall surface of the concave portion 147. Each of the cleaning members 130 is accommodated in the concave portion 147 such that the end thereof close to the first transfer path 22 comes into contact with the stopper 149.

The cleaning members 130 function to remove, for example, paper powder, ink, or dust adhered to the feed rollers 25. It is advantageous if the cleaning members 130 can be elastically deformed. For example, rubber, brush, or felt may be used as the cleaning member 130, but the invention is not limited thereto. An appropriate member may be used as the cleaning member in consideration of a material forming the roller surfaces of the feed rollers 25.

Next, a variation in the posture of the arm 26 due to the sliding of the second tray 21 will be described.

FIGS. 7A to 7C are diagrams schematically illustrating the sheet cassette 70. Specifically, FIG. 7A shows the second tray 21 at a first position, FIG. 7B shows the second tray 21 at a second position, and FIG. 7C shows the second tray 21 at a third position.

The sliding portion 106 of the second tray 21 slides relative to the main tray 20 in the insertion direction 90 or the drawing direction 92 such that the second tray 21 is disposed at the first position, the second position, or the third position. Although not shown in FIG. 7A, the sliding portion 106 is provided with a lock mechanism that restricts the sliding of the sliding portion 106 with respect to the main tray 20. A lever 39 (see FIGS. 4 and 6) is operated to release the restriction in the movement of the sliding portion 106, such that the sliding portion 106 can slide relative to the main tray 20 in the insertion direction 90 or the drawing direction 92. The second tray 21 is located at any one of the first position, the second position, and the third position by the lock mechanism of the sliding portion 106.

### <First Posture>

The sheet cassette 70 is mounted to the device body 35 with the second tray 21 being located at the first position (see FIGS. 4 and 7A) with respect to the main tray 20. In this case, the feed rollers 25 move to the main tray 20 in a space between the leading end 76 of the second tray 21 and the leading end 74 of the main tray 20, and come into contact with the recording sheets on the main tray 20. In this way, the arm 26 rotates to the first posture in which the feed rollers 25 are supported upward by the main tray 20 (see FIG. 7A). Since the arm 26 is pivoted and urged downward, the feed rollers 25 come into pressure contact with the recording sheets on the main tray 20. In this state, the feed rollers 25 are rotated to feed the recording sheet on the main tray 20 to the first transfer path 22. As such, it is possible to feed the recording sheets from the main tray 20 to the first transfer path 22, which the arm 26 maintained in the first posture.

### <Second Posture>

The sheet cassette 70 is mounted to the device body 35 with the second tray 21 being located at the second position (see FIG. 7B) with respect to the main tray 20. In this case, the leading end 74 of the main tray 20 comes into contact with the arm 26, and the arm 26 is pivoted upward about the shaft 28. In this way, the feed rollers 25 are lifted up and disposed on the lower plate 96 of the second tray 21. At that time, the arm 26 rotates to the second posture in which the feed rollers come into pressure contact with the cleaning members 130 (see FIG. 7B). Since the arm 26 is pivoted and urged downward, the feed rollers 25 come into pressure contact with the cleaning members 130 (see FIG. 7B). In this state, the feed rollers 25 are rotated and cleaned. This cleaning operation will be described in detail below.

### <Third Posture>

The sheet cassette 70 is mounted to the device body 35 with the second tray 21 being located at the third position (see FIGS. 4 and 7C) with respect to the main tray 20. In this case, the leading end 74 of the main tray 20 comes into contact with the arm 26, and the arm 26 is pivoted upward about the shaft 28. In this way, the feed rollers 25 are lifted up and disposed on the lower plate 96 of the second tray 21. At that time, the feed rollers 25 come into contact with the recording sheets on the second tray 21 (see FIG. 7C). Since the arm 26 is pivoted and urged downward, the feed rollers 25 come into pressure contact with the recording sheets on the second tray 21. In this way, the arm 26 rotates to the third position in which the feed rollers 25 come into contact with the recording sheets on the second tray 21 (see FIG. 7C). In this state, the feed rollers 25 are rotated to feed the recording sheets on the second tray 21 to the first transfer path 22.

As described above, the arm 26 changes posture among the first posture (see FIG. 7A), the second posture (see FIG. 7B), and the third posture (see FIG. 7C) in operative association with the sliding of the second tray 21 relative to the main tray 20.

The printer 11 performs image recording as follows.

The sheet cassette 70 is mounted to the device body 35 with the second tray 21 being located at the first position (see FIGS. 4 and 7A) or the third position (see FIGS. 6 and 7C) with respect to the main tray 20. In this way, the feed rollers 25 come into pressure contact with the recording sheets on the main tray 20 or the recording sheets on the second tray 21. For example, the feed rollers 25 are rotated when the control panel 14 is operated to input an instruction to start a printing operation. Then, the recording sheet on the sheet cassette 70 is fed to the first transfer path 22 in the direction of an arrow 17 (see FIG. 2). While the recording sheet is conveyed along the first transfer path 22, the forming unit 24 forms an image on one surface (a recording surface 64: see FIG. 3) of the recording sheet.

In a single-sided recording mode, the switch back roller 53 is rotated forward with the frame 55 maintained in the horizontal posture (see FIG. 3). Then, the recording sheet 65 (see FIG. 3) having the image formed on the recording surface 64 thereof is discharged from the first transfer path 22 to the space 135, and then ejected from the opening 13.

When the second tray 21 is located at the third position, it is possible to form images on both surface of the recording sheet fed from the main tray 20 to the first transfer path 22. In the double-sided recording mode, the switch back roller 53 is rotated forward with the frame 55 maintained in the horizontal posture. Then, the recording sheet 65 having the image formed on the recording surface 64 thereof is conveyed to the opening 13 (the right side of the path switching unit 72 in FIG. 3). When the trailing end 62 of the recording sheet 65 reaches a position that is at the upstream side of the spurs 56 (the state shown in FIG. 3), the switch back roller 53 is rotated backward and the frame 55 changes its posture from the horizontal posture to a rotation posture. When the posture of the frame is changed, the trailing end 62 of the recording sheet 65 is pressed downward by the spurs 56 to face the second transfer path 23.

The switch back roller 53 is rotated backward with the frame 55 maintained in the rotation posture. Then, the recording sheet 65 is switched back and conveyed to the main tray 20 along the second transfer path 23. Specifically, the recording sheet 65 is conveyed to the position between the uppermost one of the recording sheets loaded on the main tray 20 and the feed rollers 25 (hereinafter, referred to as a ‘contact position’). When the trailing end 62 of the recording sheet 65 reaches the contact position, the feed rollers 25 are rotated to convey the recording sheet 65 to the upstream side of the forming unit 24 (to the upstream-side portion 46). The recording sheet 65 is reversed during the conveying process. That is, when the recording sheet 65 is conveyed onto the platen 42, the surface of the recording sheet opposite to the recording surface 64 faces the ink jet recording head 41. When the recording sheet 65 passes through the platen 42, an image is formed on the other surface (the surface opposite to the recording surface 64) of the recording sheet. When the recording sheet 65 is conveyed from the second transfer path 23 to the first transfer path 22, the arm 55 is displaced from the rotation posture to the horizontal posture. Then, when the switch back roller 53 is rotated forward, the recording sheet 65 having images formed on both surfaces thereof is discharged from the first transfer path 22 to the space 135.

When the printer 11 performs an image recording process, the feed rollers 25 are rotated while coming into pressure contact with the recording sheets on the main tray 20 (see FIG. 7A) or the recording sheets on the second tray 21 (see FIG. 7C). Therefore, paper powder or dust on the recording sheet is adhered to the feed rollers 25. When double-sided recording is performed on the recording sheets accommodated in the main tray 20, the feed rollers 25 are rotated while coming into pressure contact with the recording surface 64 (see FIG. 3) of the recording sheet 65. Ink discharged from the ink jet recording head 41 (see FIG. 2) is adhered to the recording surface 64. When the recording sheet 65 is conveyed from the second transfer path 23 to the main tray 20 without sufficiently drying the ink adhered to the recording surface 64, the ink on the recording sheet 65 is adhered to the feed rollers 25. For example, paper powder, dust, or ink is adhered to the feed rollers 25, which may causes errors in feeding the recording sheets from the main tray 20 to the first transfer path 22.

The cleaning of the feed rollers 25 is performed as follows.

When the recording sheet is not correctly conveyed from the main tray 20 or the second tray 21 to the first transfer path 22, the sheet cassette 70 is removed from the device body 35. The lever 39 is operated to slide the second tray 21, thereby locating the second tray 21 of the sheet cassette 70 at the second position. When the sheet cassette 70 is mounted to the device body 35, the arm 26 is maintained in the second posture in which the feed rollers 25 come into pressure contact with the cleaning members 130. In this way, it is possible to clean the feed rollers 25. For example, when the control panel 14 is operated to perform a cleaning operation, the feed rollers 25 are rotated and cleaned. The term ‘cleaning’ denotes an operation of rotating the feed rollers 25 while contacting the feed rollers 25 with the cleaning members 130. In this way, paper powder, ink, or dust adhered to the feed rollers 25 are removed from the feed rollers 25.

### Operations and Effects of First Exemplary Embodiment

As described above, in operative association with the sliding of the second tray 21, the recording sheets on the main tray 20 can be fed to the first transfer path 22, the recording sheets on the second tray 21 can be fed to the first transfer path 22, or the feed rollers 25 can be cleaned. In the printer 11, the above operations can be implemented by a simple operation of sliding the second tray 21.

The sheet cassette 70 is mounted to the device body 35 with the second tray 21 being located at the second position. In this way, the feed rollers 25 can come into pressure contact with the cleaning members 130, and be cleaned. Therefore, it is possible to clean the feed rollers 25 with a simple structure, without providing or removing cleaning members. In addition, since the cleaning members 130 are provided in the second tray 21, it is possible to clean the feed rollers 25 without taking out the recording sheets from the main tray 20. Further, since the cleaning members 130 are provided closer to the leading end 76 of the second tray 21 than the recording sheets loaded on the second tray 21, it is unnecessary to take out the recording sheets from the second tray 21 in order to clean the feed rollers.

When the feed rollers 25 are cleaned, the feed rollers 25 are rotated with the arm 26 maintained in the second posture (see FIG. 7B). In this case, the rotating feed rollers 25 produce a force that tries to press the cleaning members 130 into the first transfer path 22. However, since the cleaning members 130 come into contact with the stoppers 149, it is possible to prevent the cleaning members 130 from being pressed out to the first transfer path 22 while the feed rollers 25 are cleaned. This arrangement makes it possible to easily replace the cleaning members 130. However, alternatively, it is possible to fix the cleaning members 130 to the concave portions 147 by using, for example, an adhesive. If an adhesive is used, the stoppers 149 may be omitted.

As described above, the cleaning members 130 are accommodated in the concave portions 147 formed in the lower plate 96. In this case, the inclination angle of the arm 26 is larger than that of the structure in which the cleaning members 130 are provided on the upper surface of the lower plate 96. In this exemplary embodiment, since the cleaning members 130 are accommodated in the concave portions 147, it is possible to improve the contact between the cleaning members 130 and the feed rollers 25 and thus improve cleaning efficiency.

In this exemplary embodiment, the cleaning members 130 are formed of a material that can be elastically deformed, such as rubber. Therefore, when the feed rollers 25 come into pressure contact with the cleaning members 130, the cleaning members 130 closely adhere to the feed rollers 25. In this case, it is possible to improve the cleaning efficiency, compared to when the cleaning members 130 are formed of a material that cannot be elastically deformed. However, the cleaning members 130 may be formed of a material that is not elastically deformed. In this case, it is advantageous if the roller surfaces of the feed rollers 25 be formed of a material that can be elastically deformed, in order to prevent the damage of the feed rollers 25 due to the cleaning operation.

Further, in the first exemplary embodiment, the second tray 21 is slid manually. However, another method may be used to slide the second tray 21 relative to the main tray 20. For example, an actuator that slides the second tray 21 in response to instructions input to the control panel 14 may be provided in the device body 35. Alternatively, for example, the following structure may be used: the arm 55 of the path switching unit 72 is connected to the second tray 21, and the second tray 21 slides in operative association with variation in the posture of the arm 55.

Furthermore, in the first exemplary embodiment, the lever 39 is operated to release the position of the second tray 21 restricted by the lock mechanism provided in the sliding portion 106. However, it is not necessary to provide the lock mechanism and the level 39 in the sheet cassette 70. The sheet cassette 70 may be configured such that the second tray 21 slides relative to the main tray without operating the lever 39. In this case, it is possible to slide the second tray 21 without removing the sheet cassette 70 from the device body 35. That is, it is possible to change the posture of the arm 26 without removing the sheet cassette 70 from the device body 35. In this case, marks indicating the first position, the second position, and the third position of the second tray 21 may be made at the rear end of the sheet cassette 70, and the second tray 21 may be slid on the basis of the marks.

Further, in the first exemplary embodiment, the second tray 21 accommodates recording sheets for image recording, but the second tray of the invention is not limited to a tray that accommodates recording sheets. Any tray may be used as the second tray as long as the tray includes a plate member serving as a cover of the main tray 20 and the cleaning member 130 is provided in the plate member.

In the first exemplary embodiment of the invention, the double-sided recording apparatus capable of recording images on both surfaces of the recording sheet 65 is used as an example of the image forming apparatus. However, the image recoding apparatus is not limited to a double-sided recording apparatus. That is, the image forming apparatus according to the invention may be a single-sided recording apparatus capable of recording images on one surface of the recording sheet 65. However, when the image forming apparatus is applied to the double-sided recording apparatus, it is possible to remove ink adhered to the feed rollers 25.

### Second Exemplary Embodiment

Next, a second exemplary embodiment of the present invention will be described. The structure of a multifunction device 10 according to the second embodiment is similar to that according to the first exemplary embodiment except that, a sheet discharging tray 140 is used as the second tray. Therefore, in describing the second exemplary embodiment, a description of the same components as those in the first exemplary embodiment will be omitted.

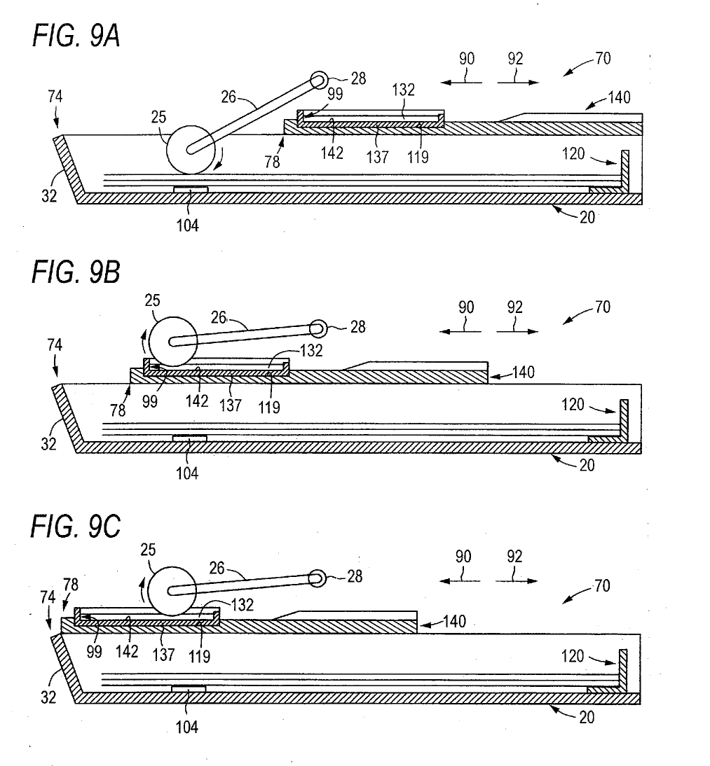

FIGS. 8A to 8C are diagrams schematically illustrating the appearance of the sheet cassette 70, in which the feed rollers 25 come into pressure contact with a cleaning member 132. FIGS. 9A to 9C are diagrams schematically illustrating the internal structure of the sheet cassette 70, in which the sheet discharging tray 140 slides relative to the main tray 20. In FIGS. 9A to 9C, the extension tray 114 is not shown.

As shown in FIGS. 8A to 8C and FIGS. 9A to 9C, the sheet cassette 70 according to the second exemplary embodiment includes the main tray 20 and the sheet discharging tray 140. The main tray 20 and the sheet discharging tray 140 are provided in a two-stage structure in the vertical direction. That is, the sheet discharging tray 140 is provided on the main tray 20. The sheet discharging tray 140 is arranged in the space 135 by mounting the sheet cassette 70 to the device body 35. A recording sheet having images formed thereon is discharged from the first transfer path 22 to the space 135 and then ejected from the opening 13. The sheet discharging tray 140 supports the recording sheets discharged to the space 135. Similar to the second tray 21, the sheet discharging tray 140 is configured such that the sheet discharging tray 140 can slide in the insertion direction 90 and the drawing direction 92 relative to the main tray 20.

As shown in FIGS. 8A to 8C, a guide groove 119 is formed at the center of the sheet discharging tray 140 in the first direction 94. The guide groove 119 is formed so as to be recessed from the upper surface of the sheet discharging tray 140 to the rear surface of the sheet discharging tray 140. A holding member 137 that holds the cleaning member 132 is provided in the guide groove 119.

The holding member 137 provided in the guide groove 119 forms a portion of the upper surface of the sheet discharging tray 140 (see FIGS. 8A to 8C and FIGS. 9A to 9C). The holding member 137 has a rectangular shape in plan view. As shown in FIGS. 8A to 8C, the width of the holding member 137 in the insertion direction 90 and the drawing direction 92 is slightly smaller than that of the guide groove 119 in the insertion direction 90 and the drawing direction 92. In addition, the width of the holding member 137 in the first direction 94 is considerably smaller than that of the guide groove 119 in the first direction 94. In this way, the holding member 137 can slide along the guide groove 119 in the first direction 94.

A concave portion 142 is formed in the upper surface of the holding member 137 (see FIG. 9A). A stopper 99 is provided in the concave portion 142 close to the first transfer path 22 (the left side of FIG. 9). The cleaning member 132 is accommodated in the concave portion 142 with an end of the cleaning member 132 which is close to the first transfer path 22 coming into contact with the stopper 99.

The cleaning member 132 is for removing paper powder, ink, or dust adhered to the feed rollers 25. It is advantageous if the cleaning member 132 can be elastically deformed. For example, rubber, brush, or felt may be used as the cleaning member 132, but the invention is not limited thereto. An appropriate member may be used as the cleaning member in consideration of a material forming the roller surfaces of the feed rollers 25.

The sheet discharging tray 140 slides relative to the main tray 20 in the insertion direction 90 or the drawing direction 92 to be disposed at a first position (see FIG. 8A), or a second position (see FIG. 8B or 8C).

### <First Posture>

The sheet cassette 70 is mounted to the device body 35 with the sheet discharging tray 140 being located at the first position with respect to the main tray 20. In this case, the feed rollers 25 move to the main tray 20 in a space between a leading end 78 of the sheet discharging tray 140 and the leading end 74 of the main tray 20, and come into contact with the recording sheets on the main tray 20 (see FIGS. 8A and 9A). Then, the arm 26 turns to the first posture in which the feed rollers 25 are supported upward by the main tray 20 (see FIG. 9A). Since the arm 26 is pivoted and urged downward, the feed rollers 25 come into pressure contact with the recording sheets on the main tray 20. In this state, the feed rollers 25 are rotated to feed the recording sheet on the main tray 20 to the first transfer path 22.

### <Second Posture>

The sheet cassette 70 is mounted to the device body 35 with the sheet discharging tray 140 being located at the second position with respect to the main tray 20 (see FIGS. 8B and 8C). As shown in FIGS. 9B and 9C, the length of the cleaning member 132 in the insertion direction 90 (or the drawing direction 92) is larger than that of a contact surface between the feed rollers 25 and the cleaning member 132. Therefore, in the second exemplary embodiment, the sheet discharging tray 140 has a plurality of second positions. It is possible to arbitrarily select one of the second positions of the sheet discharging tray 140 on the basis of, for example, the degree of contamination of the cleaning member 132. When the sheet cassette 70 is mounted to the device body 35, the leading end 74 of the main tray 20 comes into contact with the arm 26, and the arm 26 is pivoted upward about the shaft 28. Then, the feed rollers 25 are lifted up and disposed on the sheet discharging tray 140. At that time, the feed rollers 25 come into contact with the cleaning member 132 (see FIG. 9B or 9C). Since the arm 26 is pivoted and urged downward, the feed rollers 25 rotates to the second posture in which the feed rollers come into pressure contact with the cleaning member 132 (see FIG. 9B or 9C). In this state, the feed rollers 25 are rotated and cleaned.

The cleaning of the feed rollers 25 is performed as follows.

When the recording sheet is not correctly conveyed from the main tray 20 to the first transfer path 22, the sheet cassette 70 is removed from the device body 35. The lever 39 is operated to slide the sheet discharging tray 140 in the sheet cassette 70, thereby locating the sheet discharging tray 140 at the second position (see FIG. 8B). When the sheet cassette 70 is mounted to the device body 35, the arm 26 is maintained in the second posture in which the feed rollers 25 come into pressure contact with the cleaning member 132. In this state, the feed rollers 25 are rotated, and paper powder, ink, or dust adhered to the feed rollers 25 are removed by the cleaning member 132.

The length of the cleaning member 132 in the insertion direction 90 (or the drawing direction 92) is larger than that of the contact surface between the feed rollers 25 and the cleaning member 132. As shown in FIGS. 9C and 9D, the sheet discharging tray 140 slides in the insertion direction 90 relative to the main tray 20. Then, the position of the contact surface between the cleaning member 132 and the feed rollers 25 is changed. Therefore, it is possible to use the cleaning member 132 more times than in the structure in which the length of the cleaning member 132 in the insertion direction 90 or the drawing direction 92 is substantially equal to that of the contact surface. The posture of the arm 26 is changed with the variation in the position of the contact surface.

The width of the cleaning member 132 in the first direction 94 is larger than that of the contact surface between the feed rollers 25 and the cleaning member 132. As shown in FIGS. 8B and 8C, the holding member 137 slides along the guide groove 119 in the first direction 94. Accordingly, the position of the contact surface between the cleaning member 132 and the feed rollers 25 varies. Therefore, it is possible to use the cleaning member 132 more times than in the structure in which the width of the cleaning member 132 in the first direction 94 is substantially equal to that of the contact surface.

In other words, because the holding member 137 is moveable in both the sliding direction and the first direction and because a surface area of the holding member 137 is larger than the contact surface between the cleaning member 132 and the feed rollers 25, the position of the cleaning member 132 may be relocated once the contact surface becomes too dirty to effectively clean the feed rollers 25.

### Operations and Effects of Second Exemplary Embodiment

In operative association with the sliding of the sheet discharging tray 140 relative to the main tray 20, the recording sheets on the main tray 20 can be fed to the first transfer path 22, or the feed rollers 25 can be cleaned. In the printer 11, the above operations can be implemented by a simple operation of sliding the sheet discharging tray 140.

The sheet cassette 70 is mounted to the device body 35 with the sheet discharging tray 140 being located at the second position. In this way, the feed rollers 25 can come into pressure contact with the cleaning member 132 on the sheet discharging tray 140, and be cleaned. Therefore, it is possible to clean the feed rollers 25 with a simple structure, without providing or removing the cleaning member. In addition, since the cleaning member 132 is provided in the sheet discharging tray 140, it is possible to clean the feed rollers 25 without taking out the recording sheets from the main tray 20.

The recording sheets are fed from the main tray 20 to the first transfer path 22. Images are formed on the recording sheet while the recording sheet is conveyed along the first transfer path 22, and the recording sheet is then supported by the sheet discharging tray 140. It is possible to check whether the feed rollers 25 are disposed at the cleaning position on the basis of the position of the sheet discharging tray 140.

### Additional Exemplary Embodiments

Further, in the first exemplary embodiment, as shown in FIGS. 4 and 6, the cleaning members 130 are fixed to the lower plate 96 of the second tray 21. However, similar to the cleaning member 132, the cleaning members 130 may be formed such that the length thereof in the first direction 94 is larger than that of the contact surface between the cleaning member and the feed rollers 25 and the cleaning members 130 are movable in the first direction 94. That is, the guide grooves 119 may be formed in the lower plate 96 shown in FIG. 4 or 6, and the holding members 137 having the cleaning members 130 accommodated therein may be provided in the guide grooves 119 such that they can slide in the first direction 94. In addition, similar to the cleaning member 132, each of the cleaning members 130 may be formed such that the length thereof in the insertion direction 90 (or drawing direction 92) is larger than that of the contact surface between the feed roller 25 and the cleaning member.

While the present invention has been shown and described with reference to certain exemplary embodiments thereof, it will be understood by those skilled in the art that various changes in form and details may be made therein without departing from the spirit and scope of the invention as defined by the appended claims.

(1) According to an aspect of the exemplary embodiments, an image forming apparatus includes: a first tray that accommodates sheets; a first transfer path along which the sheet fed from the first tray is conveyed; a forming unit that forms images on the sheet while the sheet is conveyed; an arm that can be pivoted about a predetermined fulcrum in a direction in which the arm comes into contact or is separated from the first tray; a roller that is rotatably provided at a leading end of the arm and feeds the sheets on the first tray to the first transfer path; a second tray that is provided on the first tray to form a two-stage structure, and can slide in a direction in which the second tray comes into contact with or is separated from the arm; and a cleaning member that is provided on the second tray and cleans the roller. The arm changes its posture between a first posture in which the roller is supported upward by the first tray and a second posture in which the roller comes into pressure contact with the cleaning member, in operative association with the sliding of the second tray.

In the image forming apparatus having the above-mentioned structure, when a print start instruction is received, the sheet is fed from the first tray to the first transfer path. While the sheet is conveyed along the first transfer path, the forming unit forms images on the sheet. The image recording is performed by discharging ink or toner onto the sheet. The roller coming into pressure contact with the sheets on the first tray is rotated to feed the sheets to the first transfer path. The roller is provided at the leading end of the arm. The arm is configured such that it can be pivoted about a predetermined fulcrum in the direction in which the arm comes into contact with or is separated from the first tray.

The second tray is provided on the first tray. The second tray is arranged to form a two-stage structure together with the first tray. The cleaning member is provided on the second tray. The roller is cleaned by the cleaning member. The term ‘cleaning’ means an operation of rotating the roller to remove paper powder, ink, or dust from the roller while contacting the roller with the cleaning member. The cleaning member used for the cleaning operation may be, for example, rubber, brush, or felt.

The second tray is configured such that it can slide in the direction in which the second tray comes into contact with or is separated from the arm. The arm is rotated in operative association with the sliding of the second tray, and changes its posture between the first posture and the second posture. When the arm is maintained in the first posture, the roller is supported upward by the first tray. When sheets are loaded on the first tray, the roller comes into pressure contact with the sheets on the first tray. In this state, the roller is rotated to feed the sheet on the first tray to the first transfer path. When the arm is rotated in operative association with the sliding of the second tray, the roller is moved on the second tray. When the arm is maintained in the second posture, the roller comes into pressure contact with the cleaning member on the second tray. In this state, the roller is rotated and cleaned.

As described above, when the second tray slides, the arm is rotated, and the roller is cleaned. Therefore, it is possible to clean the roller with a simple structure, without providing a cleaning member or removing a cleaning member. In addition, since the cleaning member is provided on the second tray, it is possible to clean the roller without taking out sheets from the first tray.

(2) The sheets may be loaded on the second tray, and the roller may feed the sheets on the first tray or the sheets on the second tray to the first transfer path. The arm may change its posture among the first posture, the second posture, and a third posture in which the roller comes into pressure contact with the sheets on the second tray.

For example, the second tray accommodates sheets having a size different from that of the sheets loaded on the first tray. The arm is configured such that is can change its posture among the first posture, the second posture, and the third posture. In the third posture, the roller comes into pressure contact with the sheets on the second tray. When the arm is rotated in operative association with the sliding of the second tray, the roller is moved on the second tray. As a result, the roller is supported upward by the second tray, and the rollers come into pressure contact with the sheets on the second tray. In this state, the roller is rotated to feed the sheets on the second tray to the first transfer path. As such, the first tray serves as a main tray, and the second tray serves as a sub-tray. In operative association with the sliding of the second tray, the sheets on the first tray can be fed to the first transfer path, the sheets on the second tray can be fed to the first transfer path, or the roller can be cleaned. These are performed by a simple operation of sliding the second tray.

(3) The second tray may support the sheet discharged from the first transfer path.

While the sheet is conveyed along the first transfer path, images are formed on the sheet, and the sheet is supported by the second tray. The user can check whether the roller is disposed at the cleaning position on the basis of the position of the second tray.

(4) The image forming apparatus according to the above-mentioned aspect may further include a stopper that is provided on the second tray and comes into contact with an end of the cleaning member close to the first transfer path.

While the arm is maintained in the second posture, the roller is rotated. In this way, force to press out the cleaning member to the first transfer path is applied to the cleaning member. Since the cleaning member comes into contact with the stopper, it is possible to prevent the cleaning member from being pressed out to the first transfer path while the roller is cleaned.

(5) The cleaning member may be formed such that the length thereof in a direction in which the second tray slides is larger than that of a contact surface between the cleaning member and the roller.

When the second tray slides, the position of the contact surface between the cleaning member and the roller is changed. Therefore, it is possible to use the cleaning member more repeatedly than the structure in which the length of the cleaning member in the sliding direction is substantially equal to that of the contact surface.

(6) The image forming apparatus according to the above-mentioned aspect may further include a holding member that forms a portion of an upper surface of the second tray, is provided in the second tray such that it can slide in a first direction substantially orthogonal to the direction in which the second tray slides, and holds the cleaning member. The cleaning member may be formed such that the width thereof in the first direction is larger than that of the contact surface between the cleaning member and the roller.

When the holding member slides in the first direction relative to the second tray, the position of the contact surface between the cleaning member and the roller is changed. Therefore, it is possible to use the cleaning member more repeatedly than the structure in which the width of the cleaning member in the first direction is substantially equal to that of the contact surface.

(7) The second tray may include a concave portion formed in the upper surface, and the cleaning member may be accommodated in the concave portion.

The cleaning member is accommodated in the concave portion formed in the second tray. The inclination angle of the arm is considerably larger than that in the structure in which the cleaning member is provided on the upper surface of the second tray. As a result, it is possible to improve the contact between the cleaning member and the roller and thus improve cleaning efficiency.

(8) The cleaning member may be elastically deformed.

According to the above-mentioned structure, when the arm is displaced from the first posture to the second posture, the cleaning member closely adheres to the roller. As a result, cleaning efficiency is improved.

(9) The image forming apparatus according to the above-mentioned aspect may further include: a second transfer path that connects the first transfer path and the first tray and along which the sheet conveyed from the first transfer path is switched back and conveyed; and a path switching unit that discharges the sheet conveyed from the first transfer path or conveys it to the second transfer path.

While the sheet is conveyed along the first transfer path, the forming unit forms images on one surface of the sheet. In a single-sided recording mode, the sheet is discharged from the first transfer path by the path switching unit. Meanwhile, in a double-sided recording mode, the sheet is conveyed to the second transfer path by the path switching unit. The sheet is switched back and conveyed to the first tray along the second transfer path. When the roller is rotated with the arm maintained in the first posture, the sheet is conveyed to the first transfer path again. While the sheet is conveyed, the forming unit forms images on the other surface of the sheet. The sheet having images formed on both surfaces thereof is discharged from the first transfer path by the path switching unit.

When the sheet having images formed on one surface is conveyed to the first transfer path again, the roller comes into pressure contact with a recording surface. The term ‘recording surface’ is one surface of the sheet onto which ink or toner is discharged from the forming unit. When the sheet is conveyed to the first transfer path without sufficiently drying the ink or toner adhered to the recording surface, the ink or toner on the sheet is adhered to the roller. When the arm is displaced from the first posture to the second posture, the roller is rotated. In this way, the roller is cleaned, and the ink or toner adhered to the roller is removed.

According to the above-mentioned aspect of the invention, when the second tray slides, the arm is rotated, and the roller is cleaned. Therefore, it is possible to clean a roller with a simple structure, without taking out sheets from a tray, providing a cleaning member, or removing the cleaning member. In addition, since the cleaning member is provided in the second tray, it is possible to clean the roller without taking out sheets from the first tray.

What is claimed is:

1. An image forming apparatus comprising:
a first tray that accommodates sheets;
a first transfer path along which the sheet fed from the first tray is conveyed;
a forming unit that forms images on the sheet while the sheet is conveyed;
an arm that can be pivoted about a fulcrum in a direction in which the arm comes into contact with or is separated from the first tray;
a roller that is rotatably provided at a leading end of the arm and feeds the sheets from the first tray to the first transfer path;
a second tray that is provided on the first tray to form a two-stage structure, and can slide in a direction in which the second tray comes into contact with or is separated from the arm; and
a cleaning member that is provided on the second tray and cleans the roller,
wherein the arm changes posture between a first posture in which the roller is supported upward by the first tray and a second posture in which the roller comes into pressure contact with the cleaning member, in operative association with the sliding of the second tray.

2. The image forming apparatus according to claim 1,
wherein the second tray is configured to accommodate sheets,
the roller feeds the sheets from the first tray or the sheets from the second tray to the first transfer path, and
the arm changes posture among the first posture, the second posture, and a third posture in which the roller comes into pressure contact with the sheets on the second tray.

3. The image forming apparatus according to claim 1,
wherein the second tray is configured to accommodate a sheet that is discharged from the first transfer path.

4. The image forming apparatus according to claim 1, further comprising:
a stopper that is provided on the second tray and contacts an end of the cleaning member that is closest to the first transfer path.

5. The image forming apparatus according to claim 1,
wherein the cleaning member is formed such that the length thereof in a direction in which the second tray slides is larger than that of a contact surface between the cleaning member and the roller.

6. The image forming apparatus according to claim 1, further comprising:
a holding member that forms a portion of an upper surface of the second tray, is provided in the second tray such that the holding member can slide in a first direction substantially orthogonal to the direction in which the second tray slides, and holds the cleaning member,
wherein the cleaning member is formed such that the width thereof in the first direction is larger than that of the contact surface between the cleaning member and the roller.

7. The image forming apparatus according to claim 1,
wherein the second tray comprises a concave portion formed in an upper surface of the second tray, and
the cleaning member is accommodated in the concave portion.

8. The image forming apparatus according to claim 1,
wherein the cleaning member is made of an elastic material that can be elastically deformed.

9. The image forming apparatus according to claim 1, further comprising:
a second transfer path which connects the first transfer path and the first tray, and along which the sheet conveyed from the first transfer path is switched back and conveyed; and
a path switching unit that switches a transfer path of the sheet from the first transfer path to the second transfer path.

10. A sheet cassette comprising:
a first tray that accommodates sheets;
a second tray that is disposed on the first tray, wherein a length of the second tray is less than a length of the first tray such that the second tray is slidable along the first tray in a direction of insertion of the sheet cassette into an image forming apparatus; and
a cleaning member that is provided on the second tray,
wherein the second tray is slidable along the first tray between a first position in which a roller of the image forming apparatus contacts the sheets in the first tray, and a second position in which the roller contacts the cleaning member on the second tray.
